(19) United States
(12) Patent Application Publication
(10) Pub. No.: US 2007/0256851 A1
(43) Pub. Date: Nov. 8, 2007

(54) Apparatus and method for concealing conduit

(76) Inventors: Tom Kennedy, Chicago, IL (US); Kevin Beck, Middlebury, IN (US)

Correspondence Address: BRINKS HOFER GILSON & LIONE, P.O. BOX 10395, CHICAGO, IL, 60610, US

(21) Appl. No.: 11/416,671

(22) Filed: May 3, 2006

(51) Int. Cl. H02G 3/04

(52) U.S. Cl. 174/68.3

(57) ABSTRACT

A concealing member for concealing exposed conduit within a building is provided. The concealing member includes a body having a channel formed therein. The channel is adapted to receive the exposed conduit. The concealing member further includes a decorative edge. When the concealing member is secured to a structural member of the building, the channel receives the exposed conduit, thereby concealing the exposed conduit, and the decorative edge is directed outwardly to provide an aesthetic appearance for the concealing member.

### BACKGROUND

The present invention relates to exposed conduit within a building structure, and in particular, to an apparatus and method for concealing exposed conduit in residential and business structures.

Conduit generally used in residential and business structures provides a secure pathway, or raceway, for various types of wiring between locations within a building. The conduit can carry electrical wiring, data wiring, bundles of wires, or any other type of wiring to an outlet, switch, or any other type of utility receptacle such that a user can easily connect utilities to a main source from different location from the main source of the utility. Conduit generally provides protection to wiring as the wiring extends between locations within the building structure. Conduit can be made of metal, hard plastic, or a flexible material, wherein the wiring is disposed within the conduit.

In newly constructed buildings, utility wiring is typically transferred from the main source to various locations through a conduit that is disposed within a wall or framework of the building through a conduit disposed therein such that the wiring and conduit are hidden. Newly constructed buildings may also be built such that the conduit and wiring are disposed external to a wall or frame structure of the building in an exposed manner. Running the conduit in an exposed manner adjacent to a structural member of a building, such as a wall or framework, may be cost-efficient or be a simpler manner of installation than locating the conduit within a wall or framework.

In older buildings, conduit carrying the wiring was often located external to a wall for ease of construction or cost savings. The structure of the wall also made it easier to run the conduit adjacent to the outer surface of the wall, particularly if the wall was made of plaster. Maintaining conduit externally from a wall can reduce the space within a room or living space by interfering with placement of furniture adjacent to a wall. The conduit disposed external to a wall may be unattractive and not aesthetically pleasing. Repairing, renovating, or updating a room, living space, or office space having conduit disposed external to the walls may require the conduit to be relocated to within the structure of a wall. Renovation of a room or living space may also require conduit to be run as part of the overall project in which the conduit it disposed external to a wall. However, such relocation of the conduit from external to the wall or framework of the building to within the wall or framework may cause damage to the wall or the structure of the building. Further, relocating the conduit may also be both expensive and cumbersome.

### BRIEF SUMMARY

In one aspect of the present invention, a concealing member for concealing exposed conduit within a building is provided. The concealing member includes a body and a first channel. The first channel is formed along a surface of the body, and the channel is adapted to receive the exposed conduit. The concealing member also includes at least one decorative edge formed on the body.

In another aspect of the present invention, a method for concealing conduit that is exposed adjacent to a structural member of a building is provided. The method includes providing a concealing member. The concealing member includes a channel formed and at least one decorative edge. The channel is formed along a surface of the concealing member. The method further includes securing the concealing member to a structural member of the building such that the exposed conduit is receivable within the channel and the decorative edge is directed away from the structural member of the building.

Advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is an exploded view of a series of concealing members for concealing exposed conduit within a building;

FIG. 2 is a view of the concealing members of FIG. 1 in installed positions;

FIG. 3 is another exploded view of a series of concealing members for concealing exposed conduit within a building;

FIG. 4 is a view of the concealing members of FIG. 3 in installed positions;

FIG. 5A is a rear view of one embodiment of a baseboard member;

FIG. 5B is an end view of the baseboard member of FIG. 5A;

FIG. 5C is an end view of the baseboard member of FIG. 5A having an alternative decorative edge;

FIG. 5D is an end view of the baseboard member of FIG. 5A having another alternative decorative edge;

FIG. 6A is a top rear perspective view of an inner corner member;

FIG. 6B is a top front perspective view of the inner corner member of FIG. 6A;

FIG. 6C is a first side view of the inner corner member of FIG. 6A;

FIG. 6D is a second side view of the inner corner member of FIG. 6A;

FIG. 7A is a top front perspective view of an outer corner member;

FIG. 7B is a rear perspective view of the outer corner member of FIG. 7A;

FIG. 7C is a first side view of the outer corner member of FIG. 7A;

FIG. 7D is a second side view of the outer corner member of FIG. 7A;

FIG. 7E is a top view of the outer corner member of FIG. 7A;

FIG. 8A is a top perspective view of a wall member for concealing conduit;

FIG. 8B is a rear view of the wall member of FIG. 8A;

FIG. 8C is an end view of the wall member of FIG. 8A;

FIG. 9 is a front view of a plurality of concealing members disposed about a door opening;

FIG. 10A is a top perspective view of a junction cover;

FIG. 10B is a front view of the junction cover of FIG. 10A;

FIG. 10C is a rear view of the junction cover of FIG. 10A;

FIG. 10D is a side view of the junction cover of FIG. 10A; and

FIG. 10E is a top view of the junction cover of FIG. 10A.

### DETAILED DESCRIPTION OF THE DRAWINGS AND THE PRESENTLY PREFERRED EMBODIMENTS

Building structures, whether they are houses, offices, storage building, or anywhere that people may use to be out of the elements, have some form of wiring. The wiring can carry electricity, data, phone capabilities, or the like to various locations within the building structure. In some instances, it is necessary to run multiple wires to the same location or simply to a common location at which the wires then part and continue to different locations. When running multiple wires within a building structure, a conduit can be used. The conduit provides a pathway through which the wiring passes, and the conduit provides protection to the wiring within. In some buildings, the conduit is located within the walls of the structure, behind the plaster or dry wall that forms the exposed surface of the structural member of the building. However, in other buildings, the conduit is located external to the exposed surface of the building structure such that the conduit is exposed within a room, a hallway, or any area within the building structure. When the conduit is located adjacent to the exposed surface of a building structure within a living area such as an office building, home, hotel, or the like, the conduit may not be aesthetically pleasing. In other instances, it may be necessary to cover the exposed conduit or the occupants may simply desire for the conduit to be hidden. In the following description and drawings, reference is made to structural members of a building such as a wall 14 and floor 16 and it should be understood by one skilled in the art that the wall 14 and floor 16 are exemplary structural members of a building and the description of the location of different elements relative to these structural members of a building may be in relation to any other structural member of a building without limitation including, but not limited to a wall, floor, ceiling, or archway.

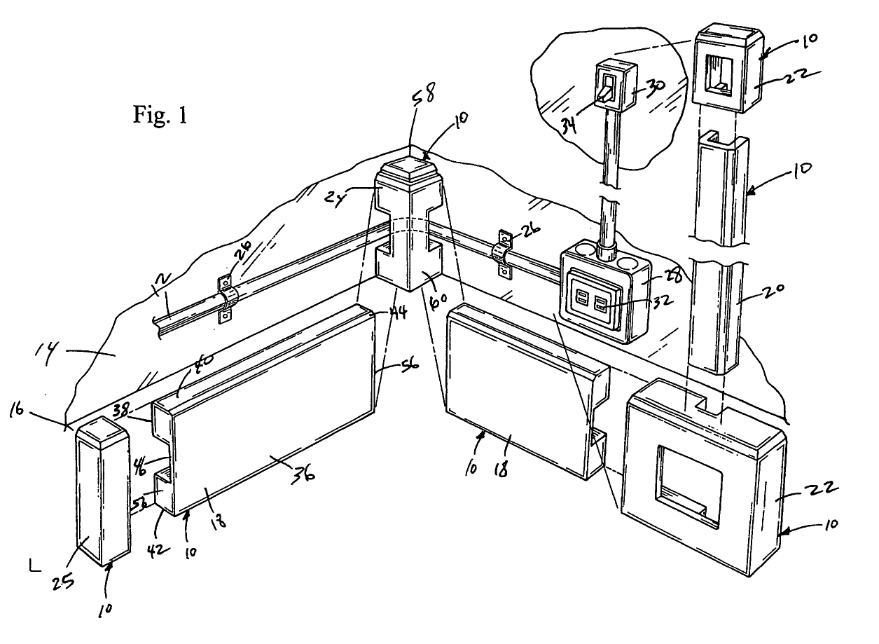

Referring to FIGS. 1-4, a plurality of conduit concealing members 10 for concealing exposed conduit 12 that is disposed adjacent to a wall 14 within a building is shown. The concealing members 10 are attachable to the wall 14, the floor 16, the ceiling, or any other structural member of a building to ensure that the concealing members 10 remain in a substantially fixed relationship relative to the conduit 12 so as to continually conceal the conduit 12. The concealing members 10 are adapted to fit around, and receive, the conduit 12 such that the conduit 12 does not need to be removed, replaced, or moved from the location at which it was installed. Each concealing member 10 is configured to provide an aesthetically appealing appearance such that when a plurality of concealing members 10 are aligned in series in order to conceal exposed conduit 12, and the overall appearance of the plurality of concealing members appears as decorative molding disposed along the edges of a room or adjacent to the structural members of the building. The concealing members 10 are adapted to conceal exposed conduit 12 as well as provide decoration to a room or area in a building. The concealing members 10 can be aligned such that a concealing member 10 conceals conduit 12 that is exposed and extends along the entire length of a wall adjacent to the floor or ceiling, the entire height of a wall, or a portion of the wall, floor, or ceiling.

The conduit 12 can be of any type or size typical for running various wires to different locations within a building structure. Conduit 12 is adapted to receive and provide protection to at least one wire within the conduit 12. Typical types of wiring can include electrical wiring, internet wiring, data wiring, or any other type of utility wiring. When the conduit 12 carrying the wiring is disposed external to the structural member of a building such as walls 14, the conduit 12 is generally disposed adjacent to the floor 16. In both newly-constructed as well as older buildings, the conduit 12 can be disposed external to a wall 14 within the building structure either during construction or during renovation. As a result, the user may want the conduit 12 to be covered in order to conceal the conduit or for the protection of the wiring within the conduit 12. The user may also desire to conceal the conduit 12 for aesthetic purposes or to prevent furniture or other users from contacting the conduit 12.

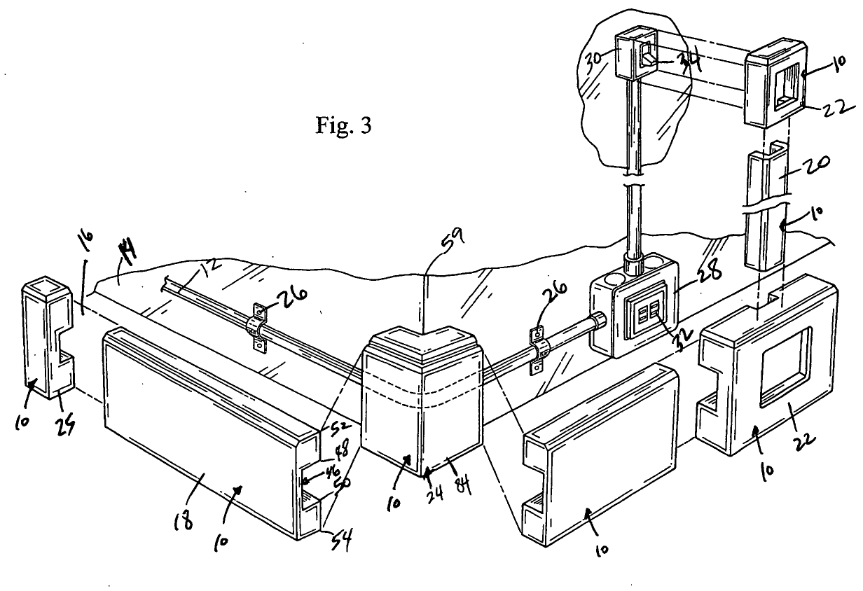

The concealing members 10 can include components such as baseboard members 18, wall members 20, junction covers 22, corner members 24, or stop members 25 that are utilized to conceal conduit 12 that is located in an exposed manner and disposed external to at least a portion of a wall 14, as shown in FIGS. 1-4. As illustrated in FIGS. 1 and 3, the conduit 12 extends adjacent to the wall 14 and spaced above the floor 16. The conduit 12 can be secured to the wall 14 by way of spaced-apart fasteners 26. Each fastener 26 is attached to the wall 14 by way of a nail, glue, or any other attaching means sufficient to allow the fastener 26 to secure the conduit 12 in a position adjacent to the wall 14. Because the wiring within the conduit 12 provides electricity, data, or other utilities, there are junctions at which the user must be able to access the utilities provided by the wiring within the conduit 12. Junctions at which the user can access the utilities carried by the wiring within the conduit 12 may include, but not limited to, an outlet box 28 or a switch box 30. The outlet box 28 may include an electrical port 32, data port (not shown), modem port (not shown) or any other port that allows the user to access the utility carried by the wiring within the conduit 12. A switch box 30 may include a switch 34 to allow the user to turn lights in the area on or off, or the switch box 30 may include any other mechanism that allows the user to access the utility of the wiring within the conduit 12 by way of a switch.

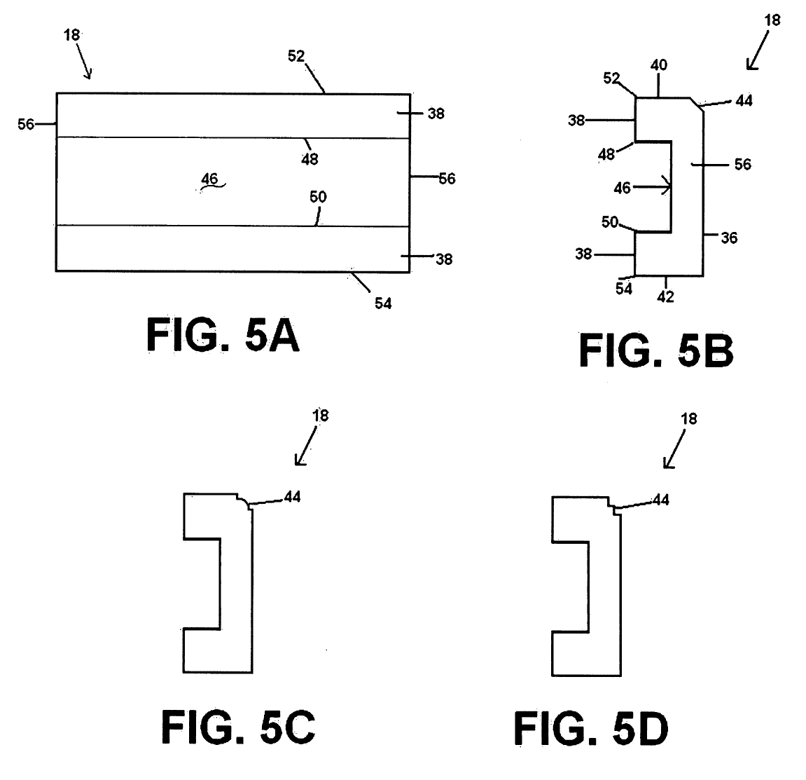

One embodiment of a baseboard member 18, as shown in FIGS. 1 and 5A-5B, is an elongated member, being generally rectangular and having a front surface 36, rear surface 38, top surface 40, bottom surface 42, a decorative edge 44, and at least one channel 46. The baseboard member 18 can be formed such that the rear surface 38 is substantially perpendicular to both the top surface 40 and the bottom surface 42, but it should be understood by one skilled in the art that the baseboard member 18 can be formed such that the angle between the rear surface 38 and the top surface 40 or between the rear surface 38 and the bottom surface 40 can be more or less than ninety (90) degrees.

A channel 46 is formed in the rear surface 38 of the baseboard member 18, and the channel 46 is adapted to receive the conduit 12 being concealed, as shown in FIGS. 1-2 and 5A-5B. The channel 46 can extend along the entire length of the rear surface 38, but it should be understood by one skilled in the art that the channel 46 can be formed through only a portion of the length of the rear surface 38 of the baseboard member 18. The channel 46 extends inward from the rear surface 38 toward the front surface 36 of the baseboard member 18. The channel 46 is preferably formed in the rear surface 38 such that the channel 46 is generally U-shaped having a substantially rectangular cross-section, but it should be understood by one skilled in the art that any cross-sectional shape of the channel 46 sufficient to receive a conduit 12 can be used. The channel 46 has a top edge 48 and a bottom edge 50 which are the edges formed as the channel 46 extends inwardly from the rear surface 38. The top edge 48 of the channel 46 is located adjacent to the upper edge 52 of the rear surface 38, and the bottom edge 50 of the channel 46 is located adjacent to the lower edge 54 of the rear surface 38. The top edge 48 of the channel 46 is preferably spaced apart from the bottom edge 50 of the channel 46 a distance that is greater than the diameter of the conduit 12 being concealed. Because the diameter of the conduit 12 may vary and the distance above the floor 16 at which the conduit 12 is mounted to the building structure may also vary, the distance between the top edge 48 of the channel 46 and the bottom edge 50 of the channel 46 should be sufficient to allow the channel 46 to receive conduit having different diameters and being disposed at different distances from the floor or other building structures.

In an exemplary embodiment of a baseboard member 18, the top edge 48 of the channel 46 is spaced from the upper edge 52 of the rear surface 38 about 1.7 inches (4.3 cm), the top edge 48 of the channel 46 is spaced apart from the bottom edge 50 of the channel 46 about 2.5 inches (6.4 cm), and the bottom edge 50 of the channel 46 is spaced apart from the lower edge 54 of the rear surface 38 about 2.3 inches (5.8 cm). It should be understood by one skilled in the art that these spaced-apart distances are for an exemplary embodiment of a baseboard member 18, and that the spaced-apart distances of other embodiments of a baseboard members 18 can vary.

The top surface 40 and the bottom surface 42 of the baseboard member 18 extend from the rear surface 38 in a substantially perpendicular manner, as illustrated in FIG. 5B. The front surface 36 of the baseboard member 18 likewise extends from the bottom surface 42 in a substantially perpendicular manner. The top surface 40 and the front surface 36 are connected by way of a decorative edge 44. The decorative edge 44 provides ornamentation for the baseboard member 18 which can add aesthetic appeal to the concealing member 10 when installed. In one embodiment, as shown in FIG. 5B, the profile of the decorative edge 44 is a sloped surface extending between the top surface 40 and the front surface 36. The angle formed by the sloped decorative edge 44 is about forty-five degrees. The angle of the sloped decorative edge 44 can be between about one (1) degrees and eighty-nine (89) degrees. In an alternative embodiment, the baseboard member 18 does not include a decorative edge such that the front surface 36 and the top surface 40 are formed substantially perpendicular to each other.

In another embodiment of the baseboard member 18, the profile of the decorative edge 44 is shaped as an inset curved surface, as illustrated in FIG. 5C. In yet another embodiment of the baseboard member 18, the profile of the decorative edge 44 is shaped as a plurality of steps, as illustrated in FIG. 5D. It should be understood by one skilled in the art that the decorative edge 44 of the baseboard member 18 is an ornamental surface that can have any shape or profile. When the baseboard member 18 is installed so as to conceal conduit 12, the decorative edge 44 is preferably directed outwardly away from the wall 14 and floor 16, thereby providing a decorative molding along a portion of the length of the wall 14. It is not necessary that the baseboard member 18 conceal conduit 12 along the entire length of the baseboard member 18 because the baseboard member 18, or a plurality of baseboard members 18 in series, can be aligned in series in order to extend along the entire length of a wall 14 while concealing conduit 12 that is exposed along only a portion of the length of the wall 14.

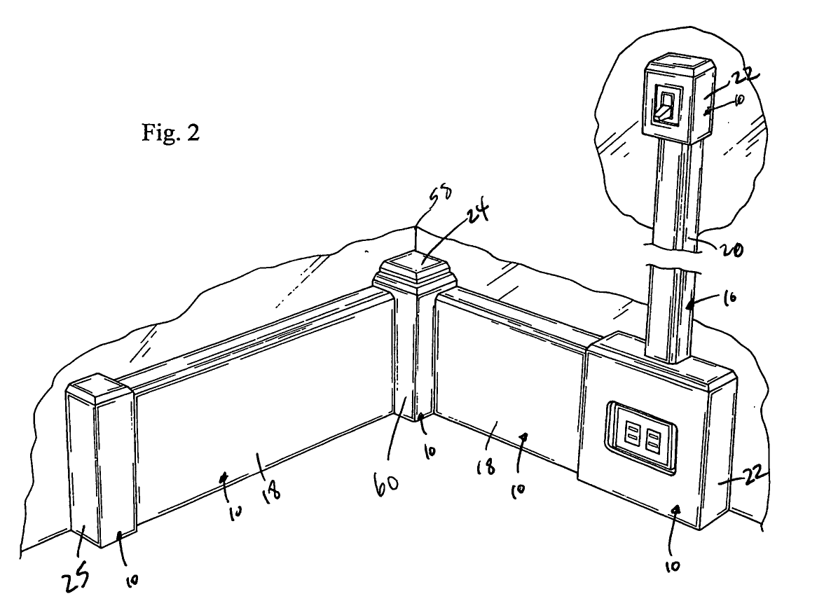

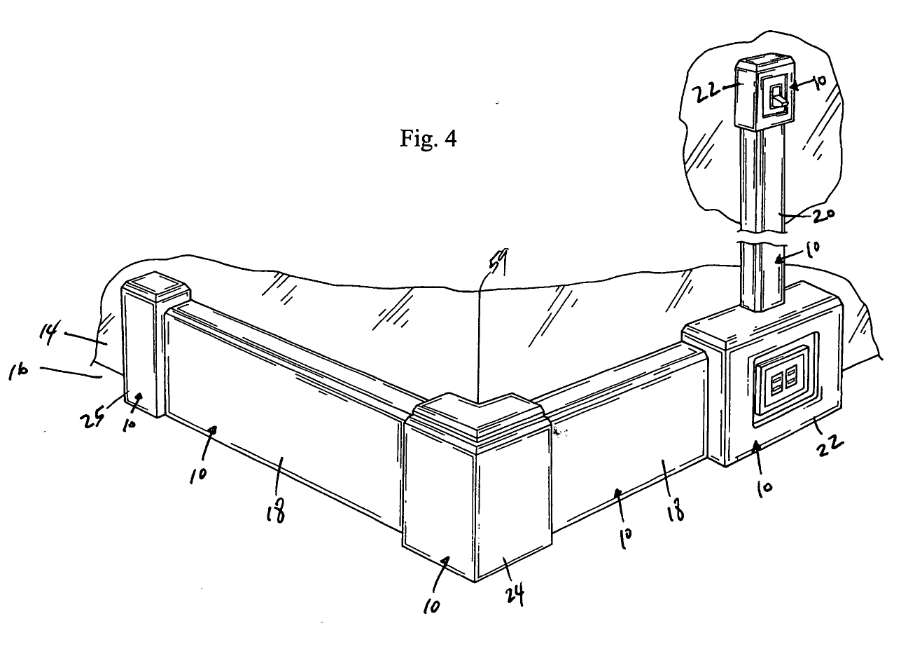

When installing the baseboard member 18 to conceal the conduit 12, the rear surface 38 is placed immediately adjacent to the wall 14 in an abutting manner and the bottom surface 42 is placed immediately adjacent to the floor 16 in an abutting manner such that the conduit 12 is received within the channel 46 formed in the rear surface 38, as illustrated in FIGS. 2 and 4. In another manner of installation, the baseboard member 18 can also be installed adjacent to a door frame (not shown) such that the rear surface 38 of the baseboard member 18 is disposed immediately adjacent to the wall 14 in an abutting manner and the bottom surface 42 is disposed adjacent to the door frame. It should be understood by one skilled in the art that the baseboard member 18 can be installed adjacent to any structural member of a building.

The baseboard member 18 is adapted to conceal conduit 12 that extends along at least a portion of a wall 14, or any other structural member of a building, in a substantially straight, parallel manner. Conduit 12 may also be redirected away from the floor 16, as shown in FIGS. 1 and 3. The baseboard member 18 may also include an aperture (not shown) that extends from the channel 46 in a transverse manner through the top surface 40 such that the baseboard member 18 can extend along the entire length of the wall 14 to provide a decorative appearance and also allow for concealment of the conduit 12 as it is redirected in a substantially perpendicular manner relative to the floor 16. Conduit 12 may also be disposed along a wall 14 having a corner such that the conduit 12 is redirected around the corner of the wall 14, as illustrated in FIGS. 1 and 3. When the conduit 12 is redirected at the corner of a wall 14, a corner member 24 can be used to conceal the conduit 12 at locations at which the baseboard member 18 may not adequately conceal the curvature that may result from the redirection of the conduit 12. One embodiment of a corner member 24 is an inner corner member 60, as illustrated in FIGS. 1-2 and 6A-6D, which is adapted to be disposed adjacent to an inner corner 58 of a wall 14, and another embodiment of a corner member 24 is an outer corner member 84, as illustrated in FIGS. 3-4 and 7A-7E, which is adapted to be disposed adjacent to an outer corner 59 of a wall 14.

One embodiment of an inner corner member 60, illustrated in FIGS. 1-2 and 6A-6D, is adapted to be disposed around an inner corner 58 of a wall 14 to conceal conduit 12 that is redirected adjacent to the inner corner 58 of a wall 14. The inner corner member 60 includes a first outer surface 62, second outer surface 64, first inner surface 66, second inner surface 68, top surface 70, bottom surface 72, and a decorative edge 74. The first and second outer surfaces 62, 64 and the first and second inner surfaces 66, 68 are elongated in the vertical direction. The first and second outer surfaces 62, 64 as well as the first and second inner surfaces 66, 68 are oriented in a substantially perpendicular manner relative to the adjacent surface of the inner corner member 60. The inner corner member 60 is shaped as a vertically-elongated member having a generally square cross-section so that the inner corner member 60 may be disposed in a position immediately adjacent to the inner corner 58 of a wall 14 when the inner corner member 60 is installed such that the first and second inner surfaces 64, 66 of the inner corner member 60 are in an abutting relationship with adjacent portions of the wall 14 that join to form the inner corner 58. When the inner corner member 60 is installed at a position immediately adjacent to an inner corner 58 of a wall 14 and the floor 16, the first and second outer surfaces 62, 64 are directed outwardly away from the wall 14 and the bottom surface 72 is in an abutting relationship with the floor 16.

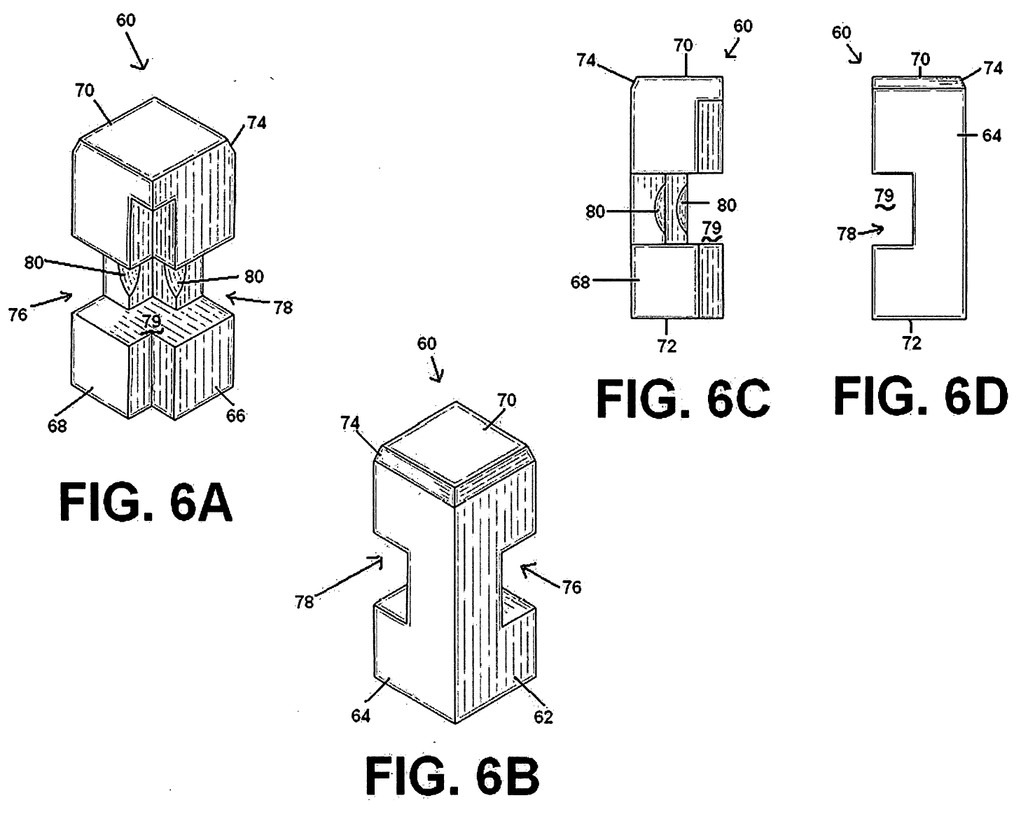

The inner corner member 60, as shown in FIGS. 6A-6D, includes a first notch 76 formed through the first outer surface 62 and a second notch 78 formed through the second outer surface 64. The first notch 76 is generally U-shaped and extends from the second inner surface 68 toward the second outer surface 64, and the second notch 78 is likewise generally U-shaped and extends from the first inner surface 66 toward the first outer surface 62. The first and second notches 76, 78 are joined through the thickness of the inner corner member 60 to form a channel 79 through which the conduit 12 being concealed is receivable. The channel 79 formed by the first and second notches 76, 78 allows the conduit 12 to be redirected around the inner corner 58 and remain concealed by the inner corner member 60, as shown in FIG. 2.

The distance that the first notch 76 extends from the second inner surface 68 and the distance that the second notch 78 extends from the first inner surface 66 should be sufficient to allow the channel 79 formed by the first and second notches 76, 78 to receive the conduit 12 that is redirected at the inner corner 58 of the wall 14. The distance that the first notch 76 extends from the second inner surface 68 and the distance that the second notch 78 extends from the first inner surface 66 should be less than the thickness of the adjacent concealing member 10 when aligned in series with other concealing members 10 such that the notches 76, 78 are not exposed when the concealing members 10 are installed. Because the radius of curvature of the conduit 12 as it is redirected around the inner corner 58 of the wall 14 may vary, the depth of the channel 79 formed by the first and second notches 76, 78 should provide sufficient clearance such that the inner corner member 60 can be located immediately adjacent to both walls forming the inner corner 58. In another embodiment, a portion of the inner corner member 60 adjacent to the intersection of the first and second notches 76, 78 can be removed, thereby forming a pair of cut-outs 80. The cut-outs 80 provide additional space within the channel 79 formed by the first and second notches 76, 78 to allow for more room for receiving conduit 12 having a larger radius of curvature. During installation, if the radius of curvature of the redirected conduit 12 is greater than the space provided by the first and second notches 76, 78, the size of the cut-outs 80 can be increased in order to accommodate the increased radius of curvature of the conduit 12.

The inner corner member 60 also includes a decorative edge 74 that extends between the first outer surface 62 and the top surface 70 as well as between the second outer surface 64 and the top surface 70, as shown in FIGS. 6A-6D. The decorative edge 74 is formed along two sides of the inner corner member 60, and when the inner corner member 60 is installed adjacent to the inner corner 58 of the wall 14, the decorative edge 74 is directed outwardly away from the inner corner 58 of the wall 14 to provide the inner corner member 60 with an ornamental edge. In one embodiment, the profile of the decorative edge 74 is a sloped surface extending between the top surface 70 and the first and second outer surfaces 62, 64. The angle formed by the sloped decorative edge 74 is about forty-five degrees. The angle of the sloped decorative edge 74 can be between about one (1) degrees and eighty-nine (89) degrees. In an alternative embodiment the inner corner member 60 does not include a decorative edge 74 such that the top surface 70 and the first and second outer surfaces 62, 64 are formed substantially perpendicular to each other. In another embodiment, the profile of the decorative edge 74 can be formed as an inset curved surface or as a plurality of steps, similar to the decorative edge 44 of the baseboard member 18 illustrated in FIGS. 5C-5D.

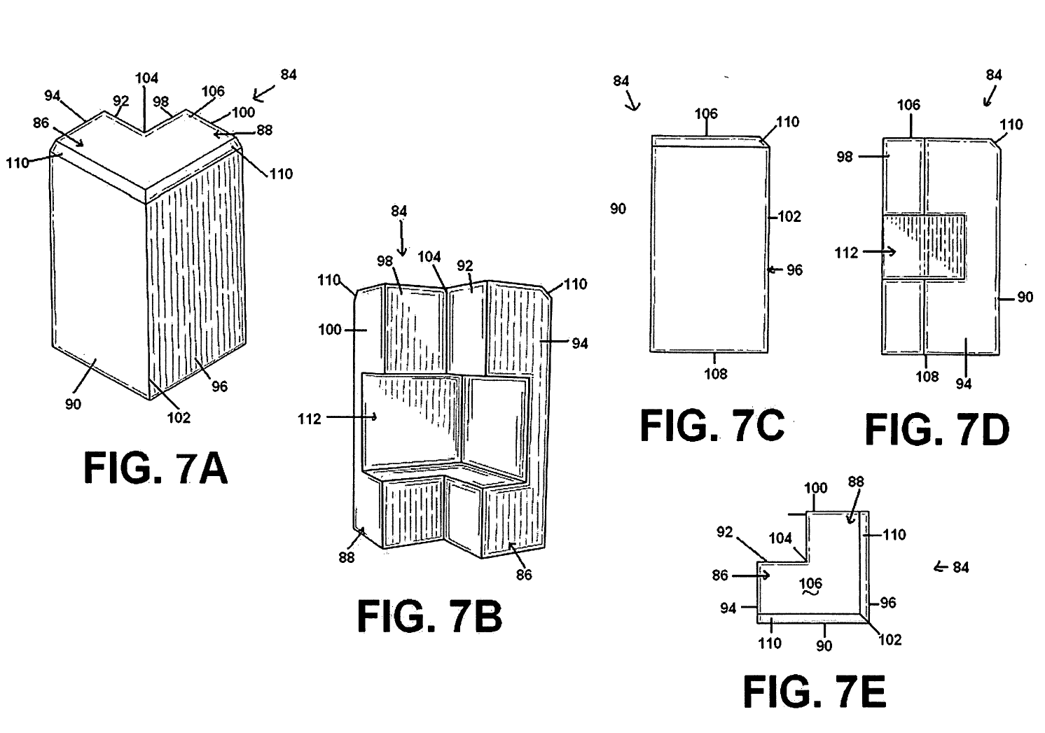

Another embodiment of a corner member 24 includes an outer corner member 84, as illustrated in FIGS. 3-4 and 7A-7E. The outer corner member 84 is adapted to be disposed adjacent to an outer corner 59 of a wall 14 to conceal conduit 12 that is redirected around the outer corner 59 of a wall 14, as shown in FIGS. 3-4. The outer corner member 84 includes a first leg 86 and a second leg 88 extending therefrom and at an angle thereto, as shown in FIGS. 7A-7E. The first leg 86 and second leg 88 are oriented at about ninety degree (90°) angle relative to each other such that the outer corner member 84 can be disposed immediately adjacent to an outer corner 59 of a wall 14. The first leg 86 of the outer corner member 84 includes an outer surface 90, inner surface 92, and a transverse surface 94 that extends between, and connects, the outer surface 90 and inner surface 92. The second leg 88 of the outer corner member 84 includes an outer surface 96, inner surface 98, and a transverse surface 100 that extends between, and connects, the outer surface 96 and inner surface 98. The outer surfaces 90, 96 are connected to form an outer proximal edge 102, and the inner surfaces 92, 98 are connected to form an inner proximal edge 104.

The outer corner member 84 further includes a top surface 106, a bottom surface 108, and a decorative edge 110, as shown in FIGS. 7A-7E. The decorative edge 110 extends between the top surface 106 and the outer surfaces 90, 96. When installed, the inner proximal edge 104 of the outer corner member 84 is disposed in an abutting manner with the outer corner 59 of the wall 14, the inner surfaces 92, 98 are in an abutting relationship with adjacent portions of the wall 14, and the decorative edge 110 is directed outwardly away from the wall 14.

In one embodiment, the profile of the decorative edge 110 can be formed as a sloped surface extending between the top surface 106 and the outer surfaces 90, 96. The angle formed by the sloped decorative edge 110 is about forty-five degrees. The angle of the sloped decorative edge 110 can be between about one (1) degrees and eighty-nine (89) degrees. In an alternative embodiment, the outer corner member 84 does not include a decorative edge 110 such that the top surface 106 and the outer surfaces 90, 96 are formed substantially perpendicular to each other. In another embodiment, the profile of the decorative edge 110 can be shaped as an inset curved surface or as a plurality of steps, similar to the decorative edge 44 of the baseboard member 18 illustrated in FIGS. 5C-5D.

The outer corner member 84 further includes a channel 112 formed through both the first and second legs 86, 88, as shown in FIGS. 7B and 7D. The channel 112 is generally U-shaped and extends from the inner surfaces 92, 98 toward the outer surfaces 90, 96. The channel 112 formed in each leg 86, 88 is adapted to receive the exposed conduit 12 that is redirected around the outer corner 59 of the wall 14. The channel 112 allows the conduit 12 to be redirected around the outer corner 59 of the wall 14 and remain concealed by the outer corner member 84, as shown in FIG. 4.

The distance that the channel 112 extends from the inner surfaces 92, 98 should be sufficient to allow the channel 112 to receive the conduit 12 that is redirected at the outer corner 59 of the wall 14. The distance that the channel 112 extends from the inner surfaces 92, 98 should be less than the thickness of the concealing member 10 located adjacent to each transverse surface 94, 100 when the outer corner member 84 is aligned in series with other concealing members 10 such that the channel 112 is not exposed when the series of concealing members 10 are installed. The inner and outer corner members 60, 84 are adapted to be disposed adjacent to a baseboard member 18 such that the concealing members 10 conceal conduit 12 that is redirected around an inner or outer corner 58, 59 or to provide a continuous decorative molding along a building structure without necessarily receiving conduit 12 within each concealing member 10. However, it should be understood by one skilled in the art that any other concealing member 10 can be disposed adjacent to the inner and outer corner members 60, 84 when installed in series. If the conduit 12 is not exposed along the entire length of the wall 14, such as shown in FIGS. 1 and 3, and a user chooses not to install a concealing member 10, or a plurality of concealing members, sufficient to extend along the entire length of the wall 14, a stop member 25 can be disposed at the end of the series of concealing members 10 to provide an aesthetic termination of the series of concealing members 10.

A stop member 25, as shown in FIGS. 1-4, is adapted to provide an end member to a concealing member 10 that conceals exposed conduit 12. The stop member 25 is formed as a vertically-elongated rectangular block having a substantially square cross-section, but it should be understood by one skilled in the art that the cross-section of stop member 25 can be any shape sufficient to allow the stop member 25 to be in an abutting relationship with a baseboard member 18 and be disposed adjacent to the wall 14. Baseboard members 18 may have a laterally-oriented channel 56 extending the entire length, and the stop member 25 is adapted to be positioned adjacent to one of the opposing side surfaces 56 of the baseboard member 18 so as to conceal the ends of the channel 56 of the baseboard member 18 as well as to provide an aesthetic termination to the series of concealing members 10. In one embodiment, the stop member 25 is a solid block, as shown in FIG. 1, having at least one decorative edge 122 formed at one end of the stop member 25, wherein the stop member 25 does not receive any portion of the exposed conduit 12. In an alternative embodiment, the stop member 25 includes a portion of a channel 124 formed through one side surface 126, as shown in FIG. 3, wherein the stop member 25 is adapted to receive a portion of the exposed conduit 12.

When a stop member 25 is installed adjacent to a baseboard member 18, the top surface 120 of the stop member 25 can be in substantially planar alignment with the top surface 40 of the baseboard member 18, but it should be understood by one skilled in the art that the top surface 120 of the stop member 25 can also be located at a position above or below the top surface 40 of the adjacent baseboard member 18. The stop member 25 can include a decorative edge 122 extending from the top surface 120 along the three side surfaces of the stop member 25 not immediately adjacent to the wall 14. The stop member 25 can be disposed at any position along the length of a wall 14 or adjacent to an inner corner 58 of a wall 14.

As the conduit 12 extends along the wall 14 in an exposed manner adjacent to the floor 16, the conduit 12 may enter an outlet box 28, as shown in FIGS. 1 and 3. The outlet box 28 may include at least one electrical port 32 to which the wiring disposed within conduit 12 is connected. The conduit 12 and wiring located within the conduit 12 may terminate at the outlet box 28. The outlet box 28 may also provide for a junction at which the conduit 12 and wiring therewithin are redirected in an upward manner along the wall 14 away from the floor 16. The conduit 12 may also exit an outlet box 28 and continue extending in substantially the same horizontal manner relative to the orientation of the conduit 12 as it entered the outlet box 28. The conduit 12 exiting an outlet box 28 may extend in an upwardly manner adjacent to the wall 14 and away from the floor 16 to a switch box 30, as shown in FIGS. 1 and 3. The switch box 30 may include a switch 34 for turning a light or other appliance operatively connected to the switch 34 on or off.

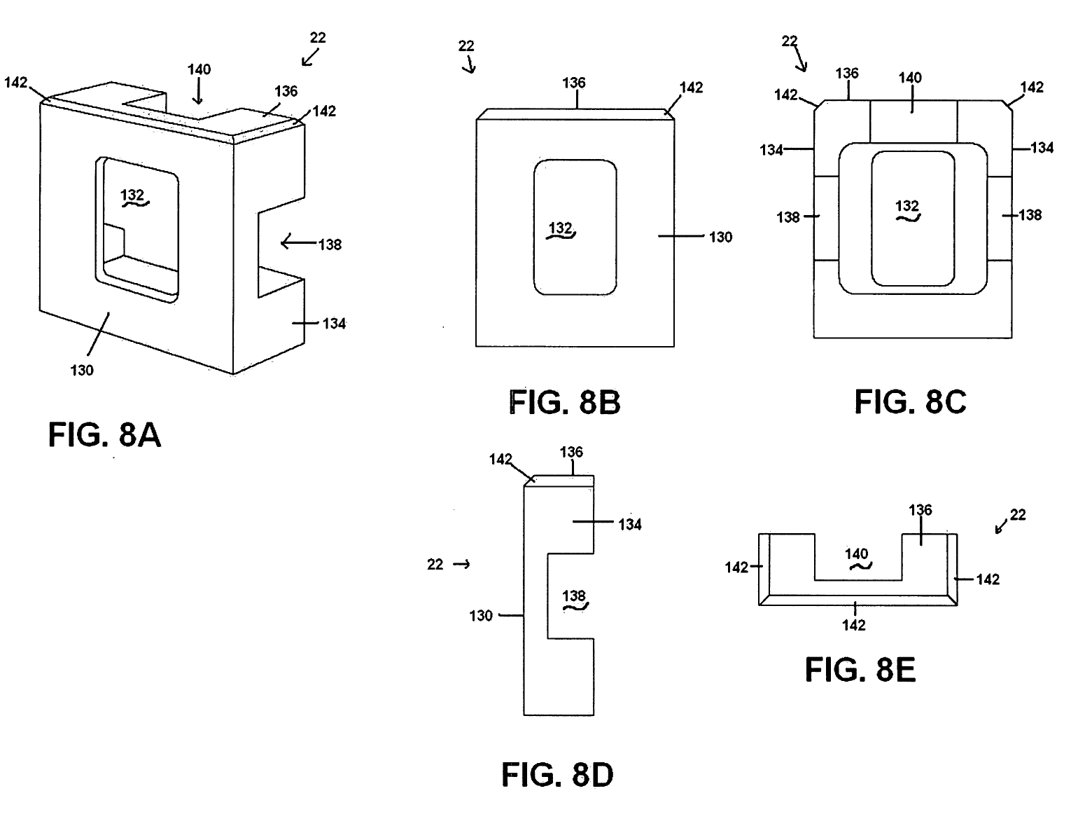

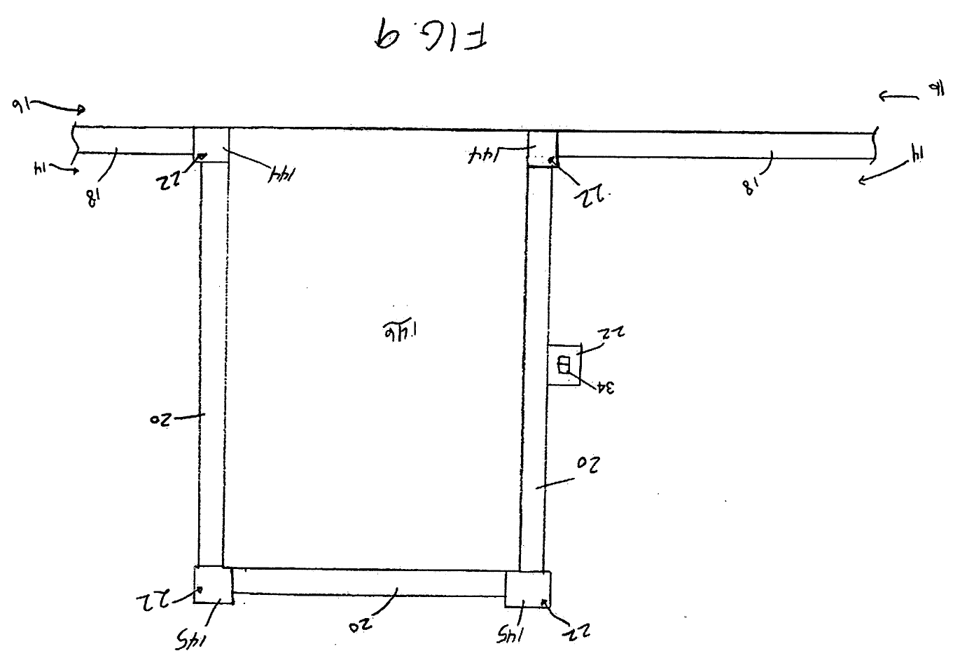

A concealing member 10 in the form of a junction cover 22 can be used to conceal the conduit 12 entering and/or exiting and outlet box 28 and the switch box 30, as shown in FIGS. 1-4, or a junction cover 22 can be used to conceal conduit 12 as it is redirected in a different direction, as shown in FIG. 9. The junction cover 22 can be configured as a hollow box having a generally square or rectangular cross-section. In one embodiment, the junction cover 22 includes a front surface 130 having a front aperture 132 formed therethrough, as shown in FIGS. 8A-8E. The outlet box 28 is adapted to extend through the front aperture 132 such that the electrical ports 32 remain accessible to a user. The junction cover 22 further includes opposing side surfaces 134, a top surface 136, a side aperture 138 formed through each of the opposing side surfaces 134, and a top aperture 140 formed through the top surface 136. The top aperture 140 can be formed through the top surface 136 such that the conduit 12 entering the junction cover 22 through a side aperture 138 can be redirected in an upwardly direction where it is received within the top aperture 140 as the conduit 12 extends outwardly from the junction cover 22. In one embodiment, a side aperture 138 is formed through the thickness of each of the opposing side surfaces 134, as illustrated in FIGS. 8C-8D. The side apertures 138 can be aligned with respect to each other. In another embodiment, as shown in FIG. 3, only one side surface 134 has a side aperture 138 formed therethough. Each junction cover 22 includes a side aperture 138 formed through one of the opposing side surfaces 134, a top aperture 140 formed through the top surface 136, or any combination thereof.

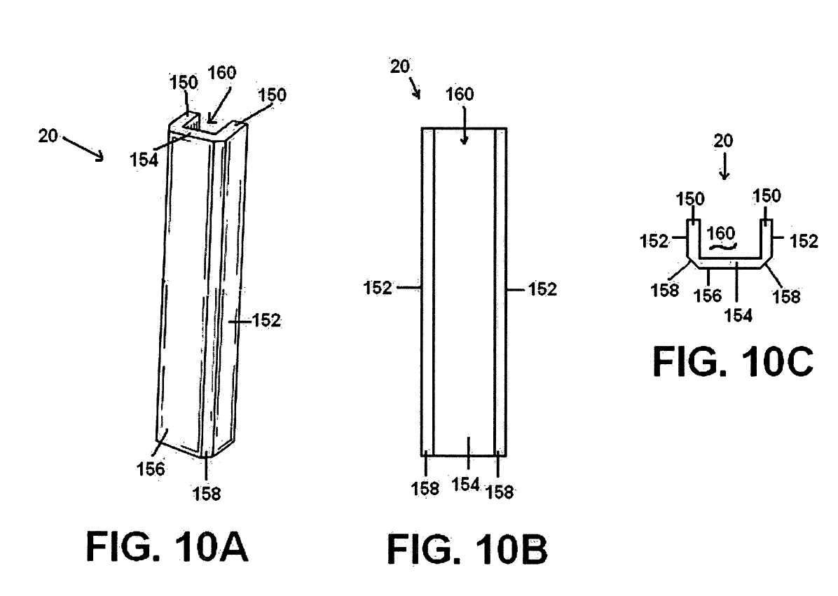

The junction cover 22 also includes a decorative edge 142 that extends between the top surface 136 and the front surface 130 as well as between the top surface 136 and each opposing side surface 134, as shown in FIGS. 10A-10E. In one embodiment, the profile of the decorative edge 142 is a sloped surface extending between the top surface 136 and the front and side surfaces 130, 134. The angle formed by the sloped decorative edge 142 is about forty-five degrees. The angle of the sloped decorative edge 142 can be between about one (1) degrees and eighty-nine (89) degrees. In an alternative embodiment the junction cover 22 does not include a decorative edge 142 such that the top surface 136 and the front and side surfaces 130, 134 are formed substantially perpendicular to each other. In another embodiment, the profile of the decorative edge 142 can be shaped as an inset curved surface or as a plurality of steps, similar to the decorative edge 44 of the baseboard member 18 illustrated in FIGS. 5C-5D.

In another embodiment, the wiring in the conduit 12 being concealed by the concealing members 10 terminates at a switch box 30 containing a switch 34 used to control a utility, as shown in FIGS. 1-2. A junction cover 22 is disposed about the switch box 30 in order to conceal the junction of the conduit and the switch box 30. Similar to the junction cover 22 configured to conceal the junction between the conduit 12 and the outlet box 28, the junction cover 22 configured to conceal the switch box 30 includes a front aperture through which the switch box 30 extends from within the junction cover 22 and a bottom aperture through which the conduit 12 enters the junction cover 22.

In a further alternative embodiment of a junction cover 22, the junction cover 22 can be formed as a plinth block 144 that can be disposed adjacent to a door opening 146, as illustrated in FIG. 9, to allow the conduit to be redirected from an orientation substantially parallel with the floor 16 to an orientation that extends away from the floor around a door opening 146. The plinth block 144 can a substantially rectangular member that is generally disposed in an abutting relationship with the floor 16 and the wall 14 adjacent to the door opening 146. However, it should be understood by one skilled in the art that the plinth block 144 can also be formed as a square or any other shaped member sufficient to allow the conduit to be redirected around a door opening 146. The plinth block 144 includes a channel formed therethrough (not shown) with a notched formed through one side in order to receive conduit entering the plinth block 144 from one direction and a similar notch formed through an adjacent side in order to allow the conduit to exit at a direction that is substantially perpendicular to the direction from which the conduit entered the plinth block 144. In an exemplary embodiment of a plinth block 144, the dimensions are about five inches by seven inches (5″×7″). The plinth block 144 can be aligned in series with other concealing members 10 in order to provide a continuous pathway for receiving and concealing exposed conduit.

In yet another alternative embodiment of a junction cover 22, the junction cover 22 can be formed as a corner block 145 that can be disposed adjacent to a door opening 146, as illustrated in FIG. 9, to allow the conduit to be redirected from an orientation substantially perpendicular to the floor 16 to an orientation that is substantially parallel with the top edge of a door opening 146. The corner block 145 can a substantially square member that is generally disposed in an abutting relationship with the floor 16 and the wall 14 adjacent to the door opening 146. However, it should be understood by one skilled in the art that the corner block 145 can also be formed as a rectangular or any other shaped member sufficient to allow the conduit to be redirected around a door opening 146. The corner block 145 includes a channel formed therethrough (not shown) with a notched formed through one side in order to receive conduit entering the corner block 145 from one direction and a similar notch formed through an adjacent side in order to allow the conduit to exit at a direction that is substantially perpendicular to the direction from which the conduit entered the corner block 145. In an exemplary embodiment of a corner block 145, the dimensions are about five inches by five inches (5″×5″). The corner block 145 can be aligned in series with other concealing members 10 in order to provide a continuous pathway for receiving and concealing exposed conduit.

Referring to FIG. 9, the junction cover 22 that is adapted to receive the switch box having a switch 34 can be disposed immediately adjacent to the wall member 20 such that the wall member 20 includes a notch (not shown) in a side surface that allows the concealed conduit to be redirected from within the wall member 20 into the junction cover 22. This allows the wires and conduit being concealed by the wall member 20 to be redirected from the substantially vertical orientation to the switch 34 enclosed within the junction cover 22. The junction cover 22 can be disposed in an abutting relationship with the wall member 20 such that no connecting concealing member 10 needs to be used to connect the wall member 20 to the junction cover 22, or the junction cover 22 can be located in a spaced-apart relationship with the wall member such that another wall member 20 can extend between the wall member 20 adjacent to the door opening 146 and the junction cover 22 in order to conceal the conduit extending therebetween. The junction cover 22 receiving the switch box and switch 34 has a notch formed in the side surface adjacent to the wall member 20 to receive the conduit that is redirected from the wall member 20.

Referring to FIGS. 1, 3 and 9, conduit 12 can be redirected such that the conduit 12 extends upwardly in a substantially vertical direction away from the floor 16. The conduit 12 can extend upwardly from an outlet box 28, be redirected from a substantially horizontal direction, or exit the wall 14 in an exposed manner in a vertical orientation. The conduit 12 can extend vertically to a switch box 30 or any other terminal receptacle for the wiring disposed within the conduit 12. As the conduit 12 extends upwardly, at least one wall member 20 is configured to conceal the conduit 12. A wall member 20, as illustrated in FIGS. 10A-10C, is a generally U-shaped elongated member having a pair of opposing side walls 150. Each of the opposing side walls 150 has an outwardly-directed side surface 152. The wall member 20 also includes a front wall 154 having a front surface 156. The opposing side walls 150 form a channel 160 therebetween. The distance between the spaced-apart, opposing side walls 150 forming the channel 160 is sufficient to receive a variety of sizes of conduit 12 used to run wiring. When the wall member 20 is installed, the distal edge of each side wall 150 opposite the front wall 154 is disposed immediately adjacent to the wall 14, door opening 146, or other structural member of a building, in an abutting manner such that the channel 160 receives the conduit 12 being concealed. The wall member 20 further includes a pair of spaced-apart decorative edges 158 that extend between the front surface 156 and each of the opposing side surfaces 152.

In one embodiment, the profile of each of the decorative edges 158 of the wall member 20 is a sloped surface extending between the front surface 156 and the opposing side surfaces 152, as illustrated in FIGS. 10A and 10C. The angle formed by the sloped decorative edge 158 is about forty-five degrees. The angle of the sloped decorative edge 158 can be between about one (1) degrees and eighty-nine (89) degrees. In an alternative embodiment the wall member 20 does not include decorative edges 158 such that the front surface 156 and the opposing side surfaces 152 are formed substantially perpendicular to each other. In another embodiment, the profile of the decorative edges 158 can be shaped as an inset curved surface or as a plurality of steps, similar to the decorative edge 44 of the baseboard member 18 illustrated in FIGS. 5C-5D.

When installed, the wall member 20 can be disposed adjacent to a wall 14, door opening 146, or other building structure such that the front wall 154 and decorative edges 158 are directed outwardly away from the wall 14 and the distal edges of the opposing side walls 150 opposite the front wall 154 are in an abutting relationship with the wall 14, as shown in FIGS. 1-4 and 9. The wall member 20 is generally installed adjacent to another concealing member 10 in series such that the channel 160 of the wall member 20 aligns with a channel or exit aperture of the adjacent concealing member 10, thereby providing a continuous pathway for receiving and concealing exposed conduit 12.

A wall member 20 can be located in the middle of a wall 14 such that it is spaced apart from inner corners 58 or outer corners 59. A wall member 20 can also be disposed about a door opening 146 as a door casing, wherein the wall member 20 extends between plinth blocks 144 and corner blocks 145. In the alternative, a wall member 20 may be disposed at a position adjacent to an inner corner 58, outer corner 59, or any other wall structure such as a door frame or the like to conceal conduit 12 that is extending in the vertical direction away from the floor 16. The wall members 20 are configured to be disposed adjacent to vertical walls 14 or the ceiling (not shown) of a room so as to conceal conduit extending along these structural members of a building. It should be understood by one skilled in the art that a wall member 20 can be disposed adjacent to any wall or floor structure of a building.

Each concealing member 10 can be made of plastic, wood, metal, particle board, or any other material sufficient to receive, conceal, and protect conduit 12 and be affixed to a structural member of a building. Each concealing member 10 can be formed such that the concealing member 10 can be painted, stained, or cut to a desired length prior to being sold or by the consumer after purchase of the concealing member 10. In an exemplary embodiment, a baseboard member 18 can be formed having a length of ten feet (10 ft.). It should be understood by one skilled in the art that each baseboard member 18 can be manufactured at a different length, thereby providing the consumer with multiple lengths of baseboard members 18 from which to choose. In an exemplary embodiment, a wall member 20 can be formed having a length five feet (5 ft.). It should also be understood by one skilled in the art that each wall member 20 can be manufactured at a different length, thereby providing the consumer with wall members 20 having different lengths. It should be understood by one skilled in the art that if the length of the structural member of the building has a length greater than the length of the concealing member 10 being disposed therealong that more than one concealing member 10 can be aligned in series in order to extend the desired length along the building structural member. It should also be understood by one skilled in the art that if the length of the concealing member is longer than the desired length that the concealing member 10 can be cut to the desired length.

Each concealing member 10 includes at least one decorative edge that is located along an edge opposite the structural member of the building such as a wall, ceiling, or floor to which the concealing member 10 is secured. The decorative edge of the concealing member 10 provides a decorative appearance to each piece such that the concealing member 10 can be utilized to conceal at least a portion of exposed conduit 12 or simply be installed in a manner such that the installation appears as decorative molding along the structural member of a building. Each concealing member 10 may also include a channel or notches formed therein for receiving exposed conduit in a concealing manner. In the preferred embodiment, the size and location of the channels and notches of each concealing member 10 is located at substantially the same relative location relative to a common surface such that different types of concealing members 10 can be installed in series so that the channels and notches are aligned, thereby providing a continuous pathway along the series of adjacent concealing members 10 for receiving conduit 12. In the preferred embodiment, when the concealing members 10 are installed, the profile of the decorative edge of each adjacent concealing member 10 has substantially the same shape in order to provide a consistent decorative edge along the series of concealing members 10. If more than one concealing member 10 is necessary to conceal exposed conduit 12, the concealing members 10 should be disposed in an abutting relationship relative to the adjacent concealing member 10 to provide a seamless appearance between sequential concealing members 10.

Installation of the concealing members 10 can be done during construction of a new building in which conduit 12 is located an exposed manner relative to walls and other structural members, during rehab of an older building already having exposed conduit 12, or during renovation in which conduit 12 may be added in an exposed manner to previously-built structures in order to reduce the costs of tearing out walls 14 to conceal the conduit 12 and wiring. When conduit is installed in a building in an exposed manner such that the conduit is located external and adjacent to a building structural member, such as a wall, floor, or ceiling, the conduit may extend the entire length of at least one of these structural members, a portion of the entire length of at least one of these structural members, or at least a portion of the length of more than one of these structural members. The concealing members 10 are configured to conceal this exposed conduit 12 while an aesthetically appealing appearance.

FIGS. 1 and 2 illustrate one method of installing concealing members 10 in a manner to conceal exposed conduit 12. The conduit 12 exits the wall 14 such that the conduit 12 is exposed at a position spaced apart from the inner corner 58 of the wall 14. The conduit 12 extends along the wall 14 in a substantially parallel manner relative to the floor 16. The conduit 12 is redirected around the inner corner 58 of the wall 14 and is received by an outlet box 28. The conduit 12 exits the outlet box 28 in an upward direction away from the floor 14 to a switch box 30. The concealing members 10 are disposed adjacent to the floor 16 and the wall 14 such that the exposed conduit 12 is concealed. The inner corner member 60 is disposed in an abutting relationship with the inner corner 58 of the wall 14 such that the decorative edges 74 of the inner corner member 60 are directed outwardly away from the inner corner 58. The inner corner member 60 is secured to the wall 14, the floor 16, or both by way of adhesive applied to first and second inner surfaces 66, 68. It should be understood by one skilled in the art that the concealing members 10 can be secured to a structural member of a building by way of a nail, glue, or any other securing mechanism sufficient to maintain the concealing members 10 in an abutting relationship with the corresponding structural member of the building.

A junction cover 22 having a side aperture 138 and a top aperture 140 is disposed about the outlet box 28 in an abutting relationship with the wall 14 and the floor 16. The junction cover 22 is secured to the wall, floor, or both such that the electrical port 32 is protruding through the front aperture 132 of the junction cover 22. Another junction cover 22 having an aperture formed through the bottom wall is disposed about the switch box 30 in an abutting relationship with the wall 14. A stop member 25 is then secured to the wall, floor, or both at a position adjacent to the location at which the conduit 12 exits the wall 14 in an exposed manner. Once the inner corner member 60, stop member 25, and junction covers 22 are secured, a baseboard member 18 is disposed about the exposed conduit 12 extending between the stop member 25 and the inner corner member 60.

If the length of the baseboard member 18 is greater than the distance between the stop member 25 and the inner corner member 60, the baseboard member can be cut to the appropriate length such that the opposing side surfaces 56 of the baseboard member 18 are in an abutting relationship with the stop member 25 and the inner corner member 60 when the baseboard member 18 is disposed therebetween. The baseboard member 18 is then secured to the wall 14, floor 16, or both. If the length of the baseboard member 18 is less than the distance between the stop member 25 and the inner corner member 60, one baseboard member 18 is disposed between the stop member 25 and the inner corner member 60 such that the baseboard member 18 is in an abutting relationship with either the stop member 25 or the inner corner member 60 and is secured to the wall 14, floor 16, or both. Another baseboard member 18 is then disposed between the baseboard member 18 and the concealing member against which the first baseboard member 18 is not abutting. If the length of the second baseboard member 18 is greater than the remaining distance to conceal the conduit 12, the second baseboard member 18 can be cut to a length sufficient to provide a seamless series of concealing members between the stop member 25 and the inner corner member 60.

In a similar manner, at least one baseboard member 18 is secured to the wall 14, floor 16, or both as well as to the inner corner member 60 and junction cover 22 covering the outlet box 28. In a manner similar to the installation of a baseboard member 18, at least one wall member 20 is disposed between the junction cover 22 covering the outlet box 28 and the junction cover 22 covering the switch box 30. The wall member 20 is secured to the wall 14 such that the channel 160 of the wall member 20 receives the exposed conduit 12, thereby concealing the conduit 12 that extends between the switch box 30 and the outlet box 28.

When installing the baseboard members 18 and wall members 20, the channel 46, 160 of each baseboard member 18 or wall member 20 disposed in series is aligned with each other as well as with a channel or notch formed in the concealing member 10 located at each end of the series of baseboard members 18 or wall members 20 to provide a continuous pathway for receiving the exposed conduit 12.

In an alternative method for concealing conduit, as illustrated in FIGS. 1 and 2, the stop member 25 may be located at the end of the wall 14 opposite the inner corner 58 such that the baseboard member 18 extends beyond the point at which the conduit 12 exits the wall 14. Although the baseboard member 18 extends beyond the entrance point of the conduit 12 such that a portion of the baseboard member 18 does not receive a portion of exposed conduit 12, the baseboard member 18 can provide a decorative molding along the entire length of the wall 14.

Another method for concealing exposed conduit 12 is illustrated in FIGS. 3 and 4. In the same manner as the method for concealing conduit explained above with respect to FIGS. 1-2, an end member 25 is secured to the wall 14 at a position adjacent to the point at which the conduit 12 becomes exposed and junction covers 22 are disposed about a switch box 30 and an outlet box 28. Exposed conduit 12 is redirected around an outer corner 59 of the wall 14, and the redirected conduit 12 is concealed by an outer corner member 84. The outer corner member 84 is disposed in a position adjacent to the outer corner 59 of the wall 14 such that the inner proximal edge 104 of the outer corner member 84 is in an abutting relationship with the outer corner 59 of the wall 14 and the outer proximal edge 102 of the outer corner member 84 is directed outwardly away from the outer corner 59 of the wall. The inner surfaces 98 of the outer corner member 84 are disposed in an abutting relationship with the walls 14 extending from the outer corner 59. The outer corner member 84 is secured to the wall 14, the floor 16, or both by way of an adhesive applied to the inner surfaces 98 of the outer corner member 84.

Once the outer corner member 84, stop member 25, and junction covers 22 are secured, as shown in FIGS. 3-4, at least one baseboard member 18 is disposed between the stop member 25 and the outer corner member 84. The baseboard member 18 is secured to the wall 14 and the floor 16 such that the baseboard member 18 is in an abutting relationship with the stop member 25 and the outer corner member 84 such that the decorative edge 44 of the baseboard member 18 is directed outwardly. At least one baseboard member 18 is also disposed between the outer corner member 84 and the junction cover 22 disposed about the outlet box 28. The baseboard member 18 is secured to the wall 14 and the floor 16 such that the baseboard member 18 is in an abutting relationship with the outer corner member 84 and the junction cover 22 such that the decorative edge 44 of the baseboard member 18 is directed outwardly. Also, at least one wall member 20 is disposed between the junction cover 22 covering the outlet box 28 and the junction cover covering the switch box 30. The wall member 20 is secured to the wall 14 such that the wall member 20 is in an abutting relationship with both junction covers 22 and the decorative edges 158 of the wall member 20 are directed outwardly. Each baseboard member 18 and wall member 20 is installed such that the channel 46, 160 receives the exposed conduit over which the baseboard member 18 and wall member 20 are disposed.

It should be understood by one skilled in the art that the concealing members 10 can be arranged, or aligned, in a manner to conceal exposed conduit 12 or the concealing members 10 can be arranged, or aligned, in a manner to provide a decorative molding along the edge of the floor and wall without receiving exposed conduit 12 along the entire length of the installed concealing members 10.

It is therefore intended that the foregoing detailed description be regarded as illustrative rather than limiting, and that it be understood that it is the following claims, including all equivalents, that are intended to define the spirit and scope of this invention.

1. A method for concealing conduit that is exposed adjacent to a structural member of a building, said method comprising:
providing a concealing member, wherein said concealing member includes a channel and at least one decorative edge; and
non-removably securing said concealing member directly to said structural member of said building such that said exposed conduit is receivable within said channel.

2. The method of claim 1, wherein said channel extends at least a portion of a length of said concealing member.

3. The method of claim 1 further comprising securing a second concealing member in series with said concealing member to said structural member of said building.

4. The method of claim 3, wherein said second concealing member includes a channel formed along at least a portion of a length of said second concealing member and said channel of said second concealing member is aligned with said channel of said concealing member when said second concealing member is secured to said structural member of said building.

5. The method of claim 1 further comprising securing an outer corner member to an outer corner of a wall and disposing said outer corner member adjacent to said concealing member in an abutting relationship.

6. The method of claim 1 further comprising securing an inner corner member to an inner corner of a wall and disposing said inner corner member adjacent to said concealing member in an abutting relationship.

7. The method of claim 1 further comprising securing a stop member to said structural member of said building in an abutting relationship with said concealing member.

8. A concealing member for concealing exposed conduit within a building, said concealing member comprising:
a body configured for a direct and non-removable connection to a structural member of a building;
a first channel formed in said body, wherein said channel is adapted to receive said exposed conduit; and
at least one decorative edge formed on said body.

9. The concealing member of claim 8, wherein said channel is generally U-shaped.

10. The concealing member of claim 8, wherein said body includes a second channel formed along said surface of said body, said second channel extending from said first channel in a substantially perpendicular manner.

11. The concealing member of claim 8, wherein said body is formed as an outer corner member that can be securable to an outer corner of a wall.

12. The concealing member of claim 11, wherein said outer corner member includes a first leg having an inner surface and an outer surface and a second leg having an inner surface and an outer surface, said second leg extending from said first leg in a substantially perpendicular manner.

13. The concealing member of claim 12, wherein said first channel is formed in said inner surface of said first leg and said inner surface of said second leg.

14. The concealing member of claim 12, wherein said body includes a top surface adjacent to said inner and outer surfaces of said first and second legs, said decorative edge forms a profile between said top surface and said outer surfaces of said first and second legs.

15. The concealing member of claim 14, wherein said profile of said decorative edge is formed as a forty-five degree angle extending between said top surface and said outer surfaces of said first and second legs.

16. The concealing member of claim 14, wherein said profile of said decorative edge is formed as a plurality of steps.

17. The concealing member of claim 14, wherein said profile of said decorative edge is formed as an inset curved surface.

18. The concealing member of claim 8, wherein said body is formed as an inner corner member that can be securable to an inner corner of a wall.

19. The concealing member of claim 18, wherein said inner corner member includes a first inner surface, a second inner surface, a first outer surface, and a second outer surface, said first and second inner surfaces are oriented in a substantially perpendicular manner and said channel extending between said first and second inner surfaces.

20. The concealing member of claim 19, wherein said body includes a top surface adjacent to said first and second inner surfaces as well as said first and second outer surfaces, said decorative edge forms a profile between said top surface and said first and second outer surfaces.

21. The concealing member of claim 20, wherein said profile of said decorative edge is formed as a forty-five degree angle extending between said top surface and said first and second outer surfaces.

22. The concealing member of claim 20, wherein said profile of said decorative edge is formed as a plurality of steps.

23. The concealing member of claim 20, wherein said profile of said decorative edge is formed as an inset curved surface.

24. The concealing member of claim 8, wherein said body is formed as a stop member.

25. The concealing member of claim 8, wherein said body is formed as a junction cover that can receive an outlet box or a switch box.

26. A concealing member for concealing exposed conduit within a building, said concealing member comprising:
a body including a first securing surface and a second securing surface, wherein said first securing surface and said second securing surface are configured to directly contact and affix to a structural member of a building;
a channel formed in said body, wherein said channel is adapted to receive an exposed conduit; and
at least one decorative edge formed on said body.

27. The concealing member of claim 26, wherein said channel is generally U-shaped.

28. The concealing member of claim 26, wherein said channel comprises a first channel, said concealing member further comprising:
a second channel formed in said body, said second channel extending substantially perpendicular from said first channel.

29. The concealing member of claim 26, wherein said body is formed as an outer corner member that can be securable to an outer corner of a wall.

30. The concealing member of claim 26, wherein said body is formed as an inner corner member that can be securable to an inner corner of a wall.

31. The concealing member of claim 26, wherein said body is formed as a stop member.

32. The concealing member of claim 26, wherein said body is formed as a junction cover that can receive an outlet box or a switch box.
